(19) United States
(12) Patent Application Publication
(10) Pub. No.: US 2020/0019365 A1
(43) Pub. Date: Jan. 16, 2020

(54) LOCATION PREDICTION SYSTEMS AND RELATED METHODS

(71) Applicant: Billups, Inc., Lake Oswego, OR (US)

(72) Inventor: Shawn Spooner, Beaverton, OR (US)

(21) Appl. No.: 16/399,532

(22) Filed: Apr. 30, 2019

Related U.S. Application Data
(60) Provisional application No. 62/698,770, filed on Jul. 16, 2018.

(51) Int. Cl. G06F 3/147; G06N 20/00; G06N 5/02; H04W 4/029; G06Q 30/02

(52) U.S. Cl. CPC G06F 3/147; G06N 20/00; G06N 5/02; G06F 3/1454; G06Q 30/0261; G06Q 30/0269; H04W 4/029

(57) ABSTRACT

A computing environment has a processor, a communication connection, and a memory. The memory contains instructions that, when executed by the processor, cause the computing environment to determine a plurality of parameters corresponding to each respective device in a plurality of devices. The instructions can cause the computing environment to assess a measure of similarity between a parameter corresponding to one of the devices and a parameter corresponding to each of the other devices in the plurality of devices. The executed instructions cause the computing environment to assign each pair of devices having a measure of similarity exceeding or falling below a threshold measure to the cohort. The executed instructions cause the computing environment to predict a second parameter value of at least one device assigned to the cohort based on a known first parameter value of the respective device and one or more changes in parameter value of other devices in the cohort of devices. The computing environment can provide an output over the communication connection in correspondence with the predicted second parameter value.

### FIELD

This application and related subject matter (collectively referred to as the “disclosure”) generally concern techniques for predicting places a person likely will visit, and related systems and methods. More particularly, but not exclusively, this disclosure pertains to predicting places a person will visit based at least in part on observed behaviors of one or more members of a cohort to which the person belongs. In some respects, this disclosure further pertains to curating content responsive to such predictions.

### BACKGROUND INFORMATION

Conventional channels for visual advertising include television and online advertising, as well as advertising on billboards and other signage. The proliferation of subscription-based video services, digital video recorders (DVRs) and other time-shifting tools has decreased the reach and frequency, and thus the effectiveness, of television advertising.

Online advertisers can curate advertising presented to a given user based on that user's online preferences. For example, online activity by a user, e.g., browsing history, can be, and often is, collected by a variety of websites. Such websites can infer that user's preferences from the user's history of online activity, e.g., browsing history, search history, etc., and present advertisements believed to be attractive to the user based on the user's history of online activity.

Nonetheless, people spend a substantial amount of time out of the home and “on the go,” with their attention directed to things other than a network-connected computer or other computing environment. Consequently, interest in out-of-home (OOH) advertising continues to increase.

And, digital billboards, kiosks and signage, together with the recent proliferation of mobile devices (e.g., smart phones, smart watches, tablet computers, connected vehicles, and other mobile computing environments), have created new opportunities for (OOH) advertising. For example, some have proposed curating advertisements presented on a billboard, kiosk, or other signage by establishing a network connection with a user's mobile device and obtaining user-preference information over the network connection. However, for security and other reasons, many users opt out of allowing their mobile device to automatically establish a network connection with an unknown network. Consequently, few, if any, mobile devices automatically establish a network connection to billboards, kiosks, or other signage, let alone share user-preference information over such a network connection.

Past approaches for predicting population movements have been based on gross observations of movements, and have yielded poor resolution and accuracy in relation to small groups of people, or individuals. For example, past observations of population movements have included tallies of the number of cars per hour (or other unit of time) that pass by a selected position on a given road. However, such tallies lack sufficient information to discriminate among individual traffic patterns (e.g., preferred routes), let alone to infer specific behaviors of individuals within the population of drivers passing the selected position.

At best, conventional approaches may yield a correlation between certain nearby activities and traffic counts, e.g., by deriving a correlation from a comparison of a number of participants in a nearby activity to observed traffic counts during selected times. Even so, such correlations are unable to predict behaviors of small groups of people or individuals.

Still further, market surveys and other conventional approaches for attempting to discern preferences define cohorts based on selected demographic characteristics and rely on active participation by members within each defined cohort. Nonetheless, such conventional approaches can become stale or insufficiently identify differences in preference among members of one or more of the defined cohorts.

### SUMMARY

Mapping and other location-based applications on mobile devices yield a wealth of location-based data pertaining to users of such devices, as well as additional (e.g., contextual) information. Due to privacy and other considerations, personally identifiable information (sometimes referred to in the art as “PII”) typically, but perhaps not always, is removed from the position data. In disclosed working embodiments, PII includes, for example, a user's name, birth date (or age), address, telephone number, credit card number, social security number, and the like, and remains unavailable to aggregators of location-based data. Accordingly, location-based data collected from a given mobile device cannot be directly parsed and assigned among conventional cohorts. Nonetheless, systems and methods described herein can predict user locations based on observations of location-based preferences. In some instances, systems and methods described herein also can curate and present content at selected locations during selected times in a manner contemplated to present the curated content to users who may find the content to be of interest.

Concepts, systems, methods, and apparatus disclosed herein overcome many problems in the prior art and address one or more of the aforementioned or other needs.

According to a first aspect, a computing environment has a display, a processor and a memory containing instructions. The instructions can be executed by the processor and cause the computing environment to predict a location of a member of a cohort of devices from a prior location of the member and a record of observations of one or more other devices in the cohort. As well, the instructions, when executed by the processor, can cause the computing environment to curate a content responsive to one or more behavioral attributes of the cohort, and to present the curated content on the display responsive to the predicted location of the member being within a selected proximity of the display.

According to one exemplary embodiment, the computing environment comprises a network-distributed computing environment.

The display can be a kiosk display. In some examples, the selected proximity measures between about 1 meter and about 5 meters.

In another example, the display can be a billboard display positioned within viewing distance of a travel corridor. In some examples, the selected proximity measures between about 100 meters and about 800 meters.

The record of observations can include a record of locations where each of the one or more other devices in the cohort has been observed, a record of behavioral attributes of each of the one or more other devices, or a combination thereof.

In some examples, the instructions, when executed by the processor, further cause the computing environment to define the cohort of devices from among a plurality of devices based on an assessment of similarity of a parameter history of each device in the plurality of devices to the parameter history of each other device in the plurality of devices. For example, the parameter history can include a record of locations where the respective device has been observed, a record of inferred activities conducted by a user of the respective device, or a combination thereof.

The display can be a first display positioned at a first location. The computing environment can include a second display positioned at a second location. The instructions, when executed by the processor, can further cause the computing environment to present the curated content on the first display responsive to the predicted location of the member being within a selected proximity of the first display. In some instances, the instructions, when executed by the processor, also cause the computing environment to present the curated content on the second display responsive to the predicted location of the member being within a selected proximity of the second display.

According to a second aspect, a computing environment has a processor, a communication connection, and a memory containing instructions. When executed by the processor, the instructions cause the computing environment to determine a plurality of parameters corresponding to each respective device in a plurality of devices. The executed instructions can also cause the computing environment to define a plurality of pairs of the devices, where each pair consists of a selected one of the plurality of devices and a selected one other of the plurality of devices. For each defined pair, the instructions, when executed by the processor, cause the computing environment to determine a measure of similarity between at least one of the parameters corresponding to one of the devices in the pair and at least one of the parameters corresponding to the other device in the pair. Further, the instructions, when executed by the processor, cause the computing environment to define a cohort of devices corresponding to each at least one of the parameters and assign to the respective cohort each pair of devices for which the corresponding measure of similarity exceeds or falls below a threshold measure of similarity. For at least one device in a selected cohort of devices, the instructions, when executed, cause the computing environment to predict a second parameter value of the respective device based on a known first parameter value of the respective device and one or more trajectories of changes in parameter value of other devices in the cohort of devices, and to provide an output over the communication connection in correspondence with the predicted second parameter value.

In some exemplary embodiments, the plurality of parameters corresponding to each respective device includes one or more position-related parameters, one or more behavior-related parameters, one or more demographic-related parameters, one or more health-related parameters, or a selected combination of one or more position-related parameters, one or more behavior-related parameters, one or more demographic-related parameters, and one or more health-related parameters. For example, the one or more position-related parameters can include one or more of a latitude, a longitude, an elevation, a date, a time, a year, a dwell, a purpose, an activity history, a transaction information, a speed of travel, a direction of travel, a weather information, an environment information, a sound information, an atmospheric information. By way of example, the one or more behavior-related parameters can include one or more of an activity, a response to a stimulus, a travel speed, a path of travel, a dwell time at a selected type of location. The one or more demographic-related parameters can include demographic information of a user of the respective device. The one or more health-related parameters can include health-related information of a user of the respective device. The measure of similarity between at least one of the parameters corresponding to one of the devices in the pair and at least one of the plurality of parameters corresponding to the other device in the pair can include a measure of similarity between at least one position-related parameter corresponding to the one of the devices and at least one of position-related parameter corresponding to the other device in the pair.

In some examples, the first parameter value is a first location characteristic and the second parameter value is a second location characteristic. The first location characteristic can be one or more of a geographic position, a business identification, a business type, an activity, a measure of weather, a landscape classification, a development classification, and a classification of wildlife habitat.

In some instances, the instructions, when executed by the processor, can further cause the computing environment to define a geographical boundary corresponding to the cohort. In some instances, the instructions, when executed by the processor, can further cause the computing environment to define an evolution of the geographical boundary over a selected time frame.

According to a third aspect, a computing environment has a display positioned in a region, a processor and a memory containing instructions. The instructions, when executed by the processor, cause the computing environment to predict a location of each member of a cohort containing a plurality of devices from a prior location of the member and a record of observations of one or more other devices in the cohort. The instructions, when executed by the processor, further cause the computing environment to assess a concentration of cohort devices within the region in relation to a threshold concentration, and to present a content on the display responsive to the assessed concentration of cohort devices exceeding the threshold concentration.

The display can be a first display, the region can be a first region, and the threshold concentration can be a first concentration. The computing environment can further have a second display positioned in a second region. The instructions, when executed by the processor, can further cause the computing environment to assess a concentration of cohort devices within the second region in relation to the second threshold concentration, and to present the content on the second display responsive to the second concentration of cohort devices exceeding the second threshold concentration.

In some instances, the first threshold concentration can be equal to the second threshold concentration. The computing environment can be a network-distributed computing environment.

The instructions, when executed by the processor, that cause the computing environment to assess a concentration of cohort devices, and can cause the computing environment, responsive to the assessed concentration of cohort devices within the region exceeding the threshold concentration, to determine a duration the assessed concentration of cohort devices within the region will exceed the threshold concentration.

The instructions that, when executed by the processor, cause the computing environment to present a content on the display, can cause the computing environment to present the content on the display during the duration the assessed concentration of cohort devices exceeds the threshold concentration.

Also disclosed are associated methods, as well as tangible, non-transitory computer-readable media including computer executable instructions that, when executed, cause a computing environment to implement one or more methods disclosed herein. Digital processors embodied in software, firmware, or hardware and being suitable for implementing such instructions also are disclosed.

The foregoing and other features and advantages will become more apparent from the following detailed description, which proceeds with reference to the accompanying drawings.

### BRIEF DESCRIPTION OF THE DRAWINGS

Referring to the drawings, wherein like numerals refer to like parts throughout the several views and this specification, aspects of presently disclosed principles are illustrated by way of example, and not by way of limitation.

FIG. 1 schematically illustrates aspects of exemplary location-prediction and content curation systems.

FIG. 2 schematically illustrates typical travel routes of two people who, at first blush, appear to have quite different demographics but nonetheless express similar preferences based on location-based data they generate.

FIG. 3 illustrates an excerpt from an example of a database containing aggregated location-based information generated through movements of a plurality of mobile devices.

FIG. 4 illustrates an excerpt from a database containing supplemental preference information that can be combined with location-based data of the type shown in FIG. 3, e.g., to determine user preferences expressed through the location-based data.

FIG. 5 illustrates aspects of a method for curating relevant content based on predicted locations of users of mobile devices.

FIG. 6 illustrates aspects of methods for predicting a parameter (e.g., a location, a travel direction, an activity, a behavior) of a mobile device (and by extension, a user of that device), and for curating relevant content based on the predicted parameter.

FIG. 7 illustrates a block diagram showing aspects of a computing environment.

### DETAILED DESCRIPTION

This application and related subject matter (collectively referred to as the “disclosure”) generally concern techniques for predicting places a person likely will visit, and related systems and methods. More particularly, but not exclusively, this disclosure pertains to predicting places a person will visit based at least in part on observed behaviors of one or more members of a cohort to which the person belongs. In some respects, this disclosure further pertains to curating content responsive to such predictions.

The following describes various principles related to predicting places a person likely will visit, and related systems and methods. For example, some disclosed principles pertain to systems, methods, and components to predicting places a person will visit based at least in part on observed behaviors of one or more members of a cohort to which the person belongs.

As but one illustrative example, location-based information can be aggregated among a large number of mobile-device users. Based on behaviors and preferences expressed by the location-based data (alone or combined with other available inference data), each user's movements can be predicted (inferred) over time using any suitable machine-learning technique. Content that may be of interest to a user (or a cohort of users) can be curated and presented, as on a digital billboard or other display within sight of a place the user (or a group of cohort members) likely will be. That said, descriptions herein of specific computing environments, apparatus or system configurations, and specific combinations of method acts, are but particular examples of contemplated computing environments, apparatus, systems, and methods chosen as being convenient illustrative examples of disclosed principles. One or more of the disclosed principles can be incorporated in various other computing environments, apparatus, systems, and methods to achieve any of a variety of corresponding, desired characteristics. Thus, a person of ordinary skill in the art, following a review of this disclosure, will appreciate that computing environments, apparatus, systems, and methods having attributes that are different from those specific examples discussed herein can embody one or more presently disclosed principles, and can be used in applications not described herein in detail. Such alternative embodiments also fall within the scope of this disclosure.

### I. Overview

Disclosed location-prediction systems and related methods can learn individual preferences, interests, or other affinities from preferences, interests, or other affinities expressed through movements of mobile devices from one place to another over time (e.g., as measured in seconds, minutes, hours, days, weeks, months, seasons, and years), particularly when such location-based data includes contextual information. Notably, disclosed systems and methods do not require, and in most instances do not have access to, any individual's personally identifiable information.

Nonetheless, disclosed location prediction systems and related methods can predict (infer), with a high-degree of accuracy, an individual's future movements from place to place, as well as the individual's future behaviors, from past movements and behaviors expressed by the individual and other similar individuals. Further, some disclosed location-prediction systems and related methods can predict, with a high-degree of accuracy, traffic volume along a travel corridor or for a business, transaction volume, revenue and/or other parameters correlated with preferences, interests, or other affinities shared among a group of individuals (e.g., a cohort).

Still further, disclosed approaches for predicting population movements allow advertisers to curate or tailor OOH advertisements to a cohort of individuals that share common preferences, interests, or other affinities, at times the cohort is expected to be present. For example, as members of a cohort migrate from place to place over time (e.g., a lunch hour, day, week, month, season, or year), advertisements likely to be of interest to members of the cohort can be presented along travel corridors used by the cohort members during times they are likely to be present along those travel corridors. Similarly, when members of a cohort are expected to be gathered in an area during certain times, disclosed content-curation systems can present content around the area tailored to interests of the cohort members.

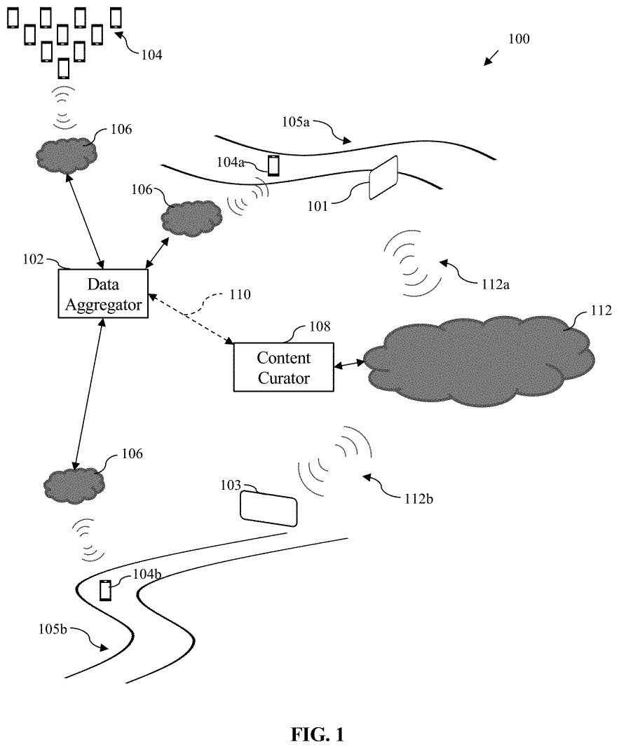

FIG. 1 schematically illustrates aspects of a location prediction system. As but one specific example of a location-prediction system, FIG. 1 shows a content-curation system 100 suited to curate content among different locations based on predicted locations of cohort at selected times.

The content-curation system 100 can tailor content to interests of different cohorts, as by presenting a first content (e.g., advertisments for running apparrel) that may be of interest to a first cohort and presenting a second content that may be of interest to a second cohort. Referring to FIG. 1, such presentation of the first content and the second content may be on a same display 101 at different times, on different displays 101, 103 at the same time, or on different displays 101, 103 at different times. Stated differently, the content curation system 100 can curate content spatially (e.g., geographically), as well as temporally (e.g., by presenting content relevant to a first cohort when the first cohort is expected to be present during a given time frame, and presenting other content relevant to a second cohort when the second cohort is expected to be present).

Referring still to the example shown in FIG. 1, a data aggregator 102 is shown. From time to time, the data aggregator 102 receives location-based data from each in a plurality 104 of mobile devices over a respective network (e.g., a wide-area network) connection 106. Mobile devices 104a, 104b are members of the plurality 104 of mobile devices and are included to illustrate that the plurality 104 of mobile devices can be geographically distributed relative to each other and/or the data aggregator 102.

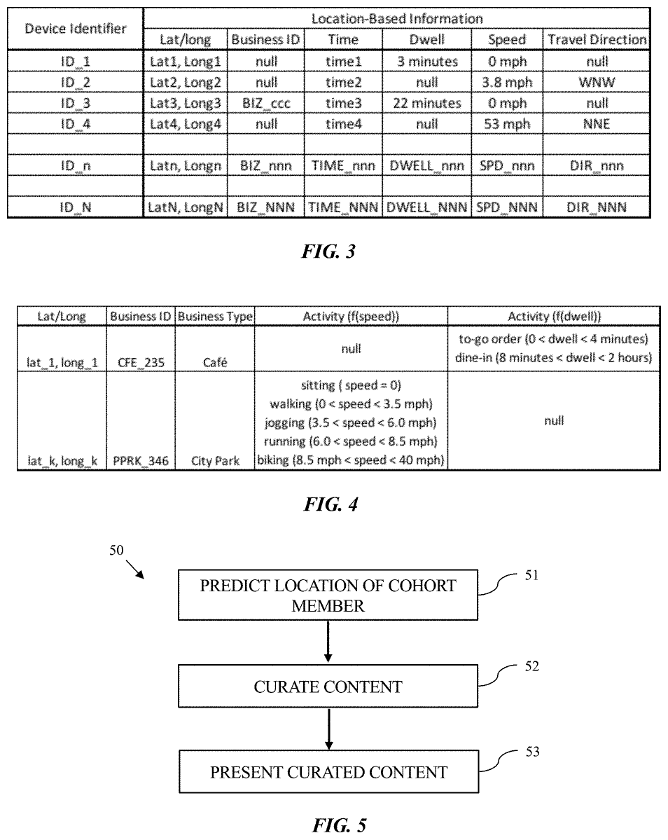

The aggregator 102 can be any computing environment programmed (by way of software, firmware, or hardware logic) to assemble or accumulate location-based data received from the plurality 104 of mobile devices into one or more aggregated databases. By way of example, such location-based data can associate a mobile-device identifier with a location (e.g., a latitude and a longitude), a time stamp indicating the time at which the location-based data was generated, and/or one or more elements of additional (e.g., contextual) information. Accordingly, a database containing aggregated location-based data can reflect movements of each mobile device during a time frame over which the aggregator 102 accumulated the location-based data. Nonetheless, the location-based data need not be, and indeed likely is not, ordered in a manner that permits straightforward extraction of historical data for any given mobile device. FIG. 3 described more fully below illustrates an example of a database containing aggregated location-based data.

In FIG. 1, a content curator 108 receives a database of location-based data aggregated by the data aggregator 102. The database received by the content curator 108 can contain location-based data generated by the mobile devices 104 during a selected time frame. The content curator 108 can be any computing environment programmed (by way of software, firmware, or hardware logic) to curate content based on inferred interests and predicted locations of members of one or more cohorts.

The content curator 108 can define a cohort of devices from among a plurality 104 of devices based on an assessment of similarity between or among the plurality 104 of devices. In some instances, similarity is assessed by comparing a parameter history of each device in the plurality 104 of devices to a parameter history of each other device in the plurality 104 of devices. By way of example, a parameter history of a given device includes an aggregation of location-based data over a selected timeframe. More particularly, but not exclusively, the parameter history for a device can include a historical record of locations where the respective device has been observed, a record of inferred activities conducted by a user of the respective device, or a combination thereof. Users of mobile devices that have visited the same (e.g., a given coffee shop, a given park, a given business) or similar (e.g., a given chain of coffee shops, a given class of park, a given type of business) locations can be determined to share similar preferences. Similarly, users who conduct the same or similar activities, as inferred from similarity of locations and location-based data, can be assessed to share similar preferences. Users of mobile devices determined to express a shared preference (e.g., based on aggregated location-based data) can be grouped together to define a corresponding cohort.

When some members of a cohort express a given behavior, activity, or preference from their location-based data, disclosed location-prediction systems can infer that other members in the cohort will also express the behavior, activity, or preference in the future. Accordingly, the content curator 108 can tailor content that may be of interest to users who express the behavior, activity, or preference.

By way of illustration, members of a cohort may be interested in bicycling and regularly ride progressively longer distances in large groups of cyclists on weekends. The members may ride solo or in smaller groups during the week, and in a pattern through winter and spring suggestive of training for long-distance bicycle races occurring over the summer. A promoter of a new long-distance bicycle race wishes to raise awareness of the race and to solicit a competitive field of riders of the type who are members of the cohort. Accordingly, the promoter can use a content curator 108 to present advertisements of the new race to members of the cohort.

For example, the content curator can display the advertisements during weekends on one or more displays 101, 103 positioned along a known route of a long-distance, weekend ride attended by members of the cohort. Taking this example further, with a sufficiently large dataset, migration of the cohort members over time can be determined with a relatively high degree of accuracy. For example, available location-based data may suggest that the cohort members predominantly reside in certain areas and predominantly commute along certain travel corridors during the week. Accordingly, the content curator can also present advertisements for the long-distance race along those certain travel corridors during the commuting rush hour.

Thus, more generally, the content curator 108 can present a curated content on a first display responsive to a prediction that a cohort member is likely to be within a selected proximity of the first display, e.g., during a first timeframe. Similarly, the content curator 108 can present the same, similar, or different curated content on a second display responsive to a prediction that the cohort member is likely to be within a selected proximity of the second display, e.g., during a second timeframe.

### II. Mobile Device Data

In some embodiments, an operating system for a mobile digital device (or other computing environment) can access a serial number or other identifier assigned to the mobile digital device or a component thereof. An identifier can include, for example, a serial number or other unique number (or combination of alpha-numeric characters) assigned to the mobile digital device or a component thereof. Such components can include, for example, a wireless radio, a processor, a memory device, a circuit board.

In other embodiments, the operating system can generate an identifier for the mobile device. In still other embodiments, another software can generate an identifier can be generated using another software. To maintain user privacy, some operating systems or other software permit a user to reset the identifier for the user's mobile device from time to time.

Regardless of its source, an identifier for a mobile device can be stored in, e.g., a volatile or a non-volatile memory. An operating system or other software can access the memory to retrieve the identifier and communicate the identifier, together with additional, e.g., contextual, information, to a data aggregator or other, e.g., cloud-based, computing environment. Regardless of the source of an identifier, neither the identifier nor the additional information needs to contain personally identifiable information belonging to the user.

Indeed, many commercial implementations of identifiers used for advertising do not provide personally identifiable information. For example, the Android® operating system available from Google Inc., and the iOS® operating system available from Apple Inc., can provide an advertising identifier for each mobile digital device on which it is running and can communicate the identifier and certain other non-personally identifiable information to a data aggregator or other, e.g., cloud-based, computing environment. In an attempt to maintain its user's confidentiality, the iOS operating system places a lower-threshold number of mobile devices (currently 5,000) in an aggregated database. However, even without containing personally identifiable information, such location-based data (e.g., identifiers combined with additional (e.g., contextual) information) can allow data aggregators and others to aggregate information about user behaviors and preferences as expressed through the location-based data. As used herein, the term “location-based data” refers to a combination of an identifier assigned to one or more mobile digital devices (or one or more components thereof) and additional (e.g., contextual) information associated with the one or more one or more mobile digital devices (or one or more components thereof).

Additional information can include information about the mobile device, e.g., keyboard language settings, device type, operating system type and version, mobile service provider, and connection type. Additional information can include one or more position-related parameters relating to a position of the mobile device, e.g., latitude, longitude, elevation, a rate-of-change in position (such as, for example, a velocity, or a speed and a trajectory), dwell (such as, for example, a duration that a mobile device remains at a position, or within a selected range of positions), a business location, a type of business, an activity predominantly occurring at the location. A position-related parameter can also include other contextual information pertaining to a position, such as, for example, a date, time, year, activity history, transaction information, weather information, environmental information, sound or acoustic information, atmospheric information, information from one or more sensors contained in or associated with the mobile device. Such sensors can include accelerometers, microphone transducers, barometers, temperature sensors, sensors sensitive to detection within a selected bandwidth of electromagnetic radiation (e.g., in an infra-red spectrum, a visible spectrum, and combinations thereof), biometric sensors (e.g., heart-rate monitors). Location-based data can be gathered from a variety of sources, including, for example, a GPS receiver in a given mobile device, a known location of a Wi-Fi transceiver with which a mobile device establishes a local network connection, a known location of one or more cell towers with which a mobile device establishes a cellular network connection or which receives a “ping” from a mobile device attempting to establish a cellular network connection.

Additional information can include one or more demographic-related parameters, one or more behavior-related parameters, and/or one or more health-related parameters. A demographic-related parameter can include, for example, gender, age, place of residence, place of work, and expressly stated preferences. A behavior-related parameter can include, for example, an activity, a response to a stimulus, a travel speed, a path of travel, a dwell time at a selected type of location. A health-related parameter can include, for example, a resting heart-rate, an age, a gender, a level of recorded activity over a selected time frame (e.g., a number of hours of cardio-vascular activity per week, during which activity, a heart-rate is maintained within a selected range). As well, additional information can be derived from one or more other elements of additional information.

### III. Location-Based Data Aggregation

Each mobile device can generate a large amount of location-based data, which, when aggregated with additional, e.g., contextual, information, can provide substantial insight to a user's behaviors and preferences. Such location-based data can include a plurality of parameters corresponding to each respective device among a plurality of devices.

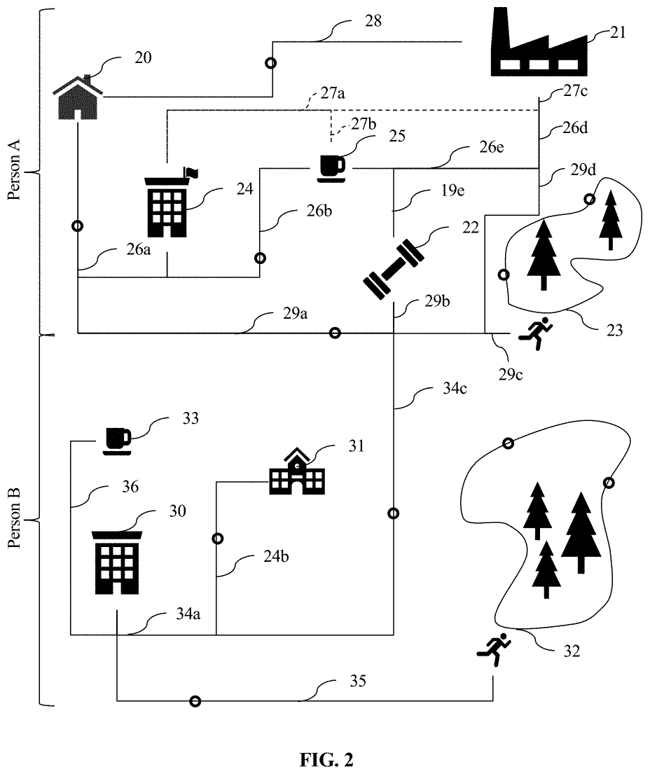

Referring now to FIG. 2, take for example Person A. Person A lives in a house 20 in a suburban neighborhood, is married with two children, works for a technology company 21 about eight miles from home 20, works out at a local gym 22 two days each week, and runs on a forested trail 23 in a nearby park two days each week. Person A typically arrives at work 21 around 9:00 a.m. after dropping the children off at school 24 and stopping off for a cup of coffee at a neighborhood coffee shop 25. While undertaking that travel, Person A typically travels along the route 26a, 26b, 26c, and 26d, despite there being an alternative route 26a, 27a, 27b, and 27c that can take Person A from home 20 to the school 24, coffee shop 25 and work 21. Person A leaves the office 21 around 5:30 p.m. each day to return home 20 along the route 18. Person A usually works from home 20 after the children are in bed. When traveling from home 20 to the gym 22, Person A typically takes the route 29a, 29b, and travels along the same route, but in reverse order, when returning home. When traveling from home 20 to the forested trail 23, Person A typically takes the route 29a, 29c and travels along the same route, but in reverse order, when returning home from the park. Occasionally, Person A leaves work 21 and travels along route 26d, 29d, 29c to the forested trail 23, or along route 26d, 26e, 29e to the gym 22.

Person B on the other hand, is a college student living in a dormitory 30 on a nearby college campus. On Monday, Wednesday, and Friday, Person B has a class in Old Main 31 that begins at 9:15 a.m., and several other classes in other buildings (omitted for clarity) until about 3:00 p.m. When traveling from the dormitory 30 to Old Main 31, Person B typically travels along route 34a, 34b. Person B works out four days each week at the same gym 22 as Person A and runs on a trail 32 through a different park than Person A three days each week. When traveling from the dormitory 30 to the gym 22, Person B typically travels along the route 34a, 34c, 29b. When traveling from the dormitory 30 to the trail 32, Person B typically travels along route 35. Person B occasionally studies in a coffee shop 33 near campus, traveling along route 36 from the dormitory 30.

In these examples, each of Person A's mobile device and Person B's mobile device has a respective mobile-device identifier. From time to time, each mobile device communicates location-based data (e.g., its mobile-device identifier, location, and additional (e.g., contextual) information) to a data aggregator or other, e.g., cloud-based, computing environment. In FIG. 2, each [symbol] represents an intermediate location from which the mobile-device communicates such location-based data. In FIG. 2, only several intermediate locations [symbol] along exemplary travel routes (and running trails) are indicated as being locations from which Person A's device and Person B's device communicates location-based data. Nonetheless, it should be understood and appreciated that such location-based data can be, and in this example is, communicated from other intermediate locations, as well as from each end-point, or node, (e.g., home 20, work 21, gym 22, trail 23, school 24, coffee shop 25, dormitory 30, Old Main 31, trail 32, and coffee shop 33) along the various depicted travel routes.

FIG. 3 shows an excerpt of aggregated location-based data of the type that can be collected from Person A's mobile device and Person B's mobile device. The table in FIG. 3 arranges location-based data in rows. The first column contains an identifier for the device that transmitted location-based data from one location, and the second column lists latitude and longitude information. The third column lists a business identifier associated with the intermediate location, and the fourth column lists the date and time at which the mobile device communicated the location-based data. The fifth column lists a duration (e.g., dwell) that the mobile device remained at the given location. The sixth column lists the speed of the mobile device at the time of communicating the location-based data, and the seventh column indicates a direction of travel for the mobile device at the time of communicating the location-based data.

The first row of data indicates that a mobile device having an identifier “ID_1” communicated location-based data from a position “Lat1, Long1.” At that location, the mobile device did not have an indication of any associated business, so the mobile device communicated a “null” reading for the Business ID. The first row also indicates that the location-based data was communicated at “time1” and that the mobile device had remained in the same general location for about 3 minutes. The device was stationary (e.g., the “speed” was indicated as being “0 mph,” and the travel direction was “null”). By contrast, the second row of location-based data for a second mobile-device identifier “ID_2” indicates that the device was located at “Lat2, Long2” at “time2” and was travelling west-northwest at 3.8 miles per hour (mph). Device “ID_3” communicated the location-based data from “Lat3, Long3” associated with a business having Business ID “BIZ_cccc” at “time3.” That device had been at that business for 22 minutes and was stationary. The fourth device identified as “ID_4” was travelling north-northeast at 53 mph.

The aggregated data set shown in FIG. 3 contains location-based data for N total devices (e.g., device identifiers ID_1 . . . ID_N, with ID_n representing the identifier for the n^{th} device). The total number of entries in the aggregated dataset is M, which is the total number of location-based data points communicated to a data-aggregator 102 by the N devices during a selected timeframe over which the data aggregator accumulated the location-based data. Of course, the location-based data shown in FIG. 3 is merely exemplary in nature and other databases can contain information pertaining to other (e.g., additional, similar, or different) parameters.

FIG. 4 illustrates still further information that can be combined with location-based data from the data aggregator 102 to infer user preferences and/or activities expressed by the location-based data accumulated in a database of the type shown in FIG. 3. For example, the first row of data in FIG. 4 indicates that a user of a mobile device that remains at a café CFE_235 located at lat_1, long_1 for fewer than 4 minutes likely purchased an order to go, whereas a user of a mobile device that remains at the café for longer than 8 minutes likely was a dine-in customer of the café. In a similar vein, a user of a mobile device that remains stationary with a city park PPRK_346, located at lat_k, long_k, is likely sitting, while a user of a mobile device that travels through the park at a speed between 8.5 mph and 40 mph is likely to be biking.

Accordingly, an aggregation of location-based data, as in FIG. 3, can be combined with preference data, as in FIG. 4, to infer an activity or a preference being expressed by a user of a mobile device through the location-based data.

In the above-described example, the content curator 108 receives aggregated location-based information from the data aggregator 102. In some instances, the content curator 108 can append or otherwise combine location-based data contained in a newly received database with location-based data contained in a previously received database (e.g., to location-based data aggregated over an earlier time frame). Similarly, the content curator 108 can combine a database of location-based data (e.g., as in FIG. 3) with preference data (e.g., as in FIG. 4) to infer behavior or preferences expressed by the location-based data before defining cohorts or curating content to one or more defined cohorts.

In some instances, the content curator 108 can receive the database of aggregated, location-based data over a communication connection 110 (e.g., a communication connection of the type described more fully below in connection with general purpose computing environments).

In FIG. 1, the communication connection 110 is shown in a dashed line to indicate that communication over the communication connection may be continuous, or may be established for a selected duration, subsequently terminated, and selectively re-established (e.g., at regular or irregular intervals). In some instances, the data aggregator 102 and the content curator 108 are combined into a local computing environment. When the data aggregator 102 and the content curator 108 are combined into a local computing environment, the communication connection 110 may be a software channel, or a physical bus (or other physical communication channel). In other instances, the data aggregator 102 and the content curator 108 are implemented over a distributed computing environment, where certain different tasks are executed remotely from each other.

In still other instances, the data aggregator 102 is implemented in a computing environment separate and distinct from the computing environment in which a content curator 108 is implemented. For example, the data aggregator 102 may be under control of an entity separate and distinct from an entity that controls the content curator 108, despite that a communication connection 110 may be established between the aggregator 102 and curator 108.

For example, an application (or “app”) developer may market and distribute a software application to end-users of mobile digital devices. The software application may provide one or more benefits to its users, and may also collect location-based information from each respective user's mobile device. The app may also cause each user's mobile digital device to communicate the location-based information (including, for example, a device identifier) to the app developer, which can aggregate the location-based information received from each user into a database. In turn, the app developer may elect to provide (e.g., over a network connection) the aggregation of location-based information to another entity for content curation. In other instances, however, the app developer may elect to maintain the aggregation of location-based information for its own (e.g., content curation) purposes.

As but one example, a content curator 108 separate from a data aggregator 102 may receive a daily update of location-based information aggregated from about 20 million mobile devices, such as, for example, between about 1 million devices and about 100 million devices, or between about 5 million devices and about 40 million devices. A database of location-based data compiled for about 20 million users may have in excess of 1 billion location-based data entries. Nonetheless, as with the database of location-based information in FIG. 3, the location-based data received from the data aggregator may be sparse, e.g., have a number of unobserved states for each user.

The received data can be cleaned (e.g., extraneous, duplicate, or irrelevant information can be removed, structural errors within the data can be resolved, and outlier data can be appropriately weighted). The cleaned data can also be processed, as by, for example, combining with one or more databases containing preference information (e.g., as described above in connection with FIG. 4). After the data is cleaned, further processing (e.g., defining behavioral cohorts, inferring travel routes, curating content, defining cohort-based market segments) can be performed as described more fully below. Such processing can, but need not, be performed in parallel.

### IV. Behavioral Cohorts

As noted above, location-based data collected from a user's mobile device can indicate preferences and/or behaviors of the user. Similarly, an aggregation of location-based data collected from a plurality of users' mobile devices can indicate preferences and/or behaviors of the plurality of users. As well, such an aggregation of data over a plurality of users can yield information regarding similarity of preferences and/or behaviors among the users. Some disclosed systems and methods assume that members of each group, or cohort, of users will express future behaviors and/or preferences similar to past behaviors and/or preferences expressed by other members of the cohort.

A location-prediction system (or a related method) can group users who express similar behaviors or preferences together into a cohort. An aggregation of location-based data can contain various (e.g., location-based) parameters for each user's mobile device. Similarity between a pair of users can be assessed based on a comparison of a parameter history of one user's device against a parameter history of the other user's device.

If a measure of similarity between those parameter histories exceeds (or falls below) a selected threshold, the users can be deemed to be similar to each other. For data aggregated from a plurality of mobile devices, similarity among the devices can be assessed by comparing a parameter history of each mobile device to a corresponding parameter history of each other device.

More generally, similarity between each pair of mobile devices, and by extension users of those devices, can be assessed for each of one or more expressions of preference or behavior. Further, each pair of devices can be ranked (or ordered) according to similarity. Given the large databases of aggregated location-based data contemplated herein, a deep neural network may be useful for determining similarity among pairs of devices, though any form of machine learning may be used to discern similarity among devices.

In one working embodiment, the model is formulated as a deep neural network which phrases the problem in terms of graph embeddings. As well, when training the model with a given database of location-based data, in-network similarity and out-of-network dissimilarity can be maximized.

A database containing location-based data for a plurality of users can be modeled according to two separate bipartite graphs: (1) users mapped to locations, along with additional information; and (2) users mapped to activity types (behaviors such as, for example, this user goes to trails to run). A bipartite graph, also called a bigraph, refers to a set of graph vertices decomposed into two disjoint sets such that no two graph vertices within the same set are adjacent (e.g., connected together by an edge). Some disclosed location-based prediction systems and related methods assume that users who embed close to each other in either of these two spaces are likely to have similar demographics and expressed behaviors.

A graph is a collection of points and a collection of lines connecting some (possibly empty) subset of the opints. The points of a graph are most commonly known as graph vertices but may also be called “nodes” or simply “points.” Similarly, the lines connecting the vertices of a graph are most commonly known as graph edges but may also be called “arcs” or “lines.” A graph embedding is a particular drawing of a graph. Accordingly, for a given device (or device identifier), each element of location-based information in an aggregation of location-based data can represent a graph vertex. A distance between the graph vertices can represent a measure of similarity between the vertices.

A graph built from points representing physical locations can represent a map of the physical world. For example, in a working embodiment, a location graph of the physical world contains over 28 million businesses in the United States. In that embodiment, the graph defines paths that lead among the various businesses, with each path corresponding to at least one mode of transportation (e.g., by walking, biking, driving, taking commercial or private common carrier via ground or air). The exemplary graph is fully traversable and follows selected rules of transport for the mode of transportation each edge represents. Stated differently, each edge is “directed.” For instance, flights start and stop at airport nodes, and more specifically, at terminal nodes in the cases of larger airports.

A graph can also represent connectivity or relationships among classes of points (or nodes) other than physical locations. For example, each point in a graph can represent a mobile communication device, and each edge connecting two points (devices) can represent a measure of similarity between the points (devices). As but one example, the connections, or edges, connecting pairs of devices can be strengthened according to a measure of location-based similarity between the devices.

In one example, such location-based similarity between a pair of devices can be based on a degree to which the pair of devices exhibit co-visitation to discrete, predefined cells (e.g., measuring about 4 meters by 4 meters) concurrently. In this example, an edge between a pair of devices is strengthened in correspondence with increasing incidence of co-visitation between the pair of devices. This graph can model observations that people (where each person is associated with a given mobile communication device) are far more influenced by those they are surrounded by than each person's demographics might otherwise suggest. Accordingly, it is surmised that these connections (edges) allow for stronger inferences than inferences based soley on demographics would otherwise permit.

Another example of a useful graph can be based on devices that visit a common location within a selected time frame (e.g., not necessarily concurrently, as with the foregoing co-visitation graph). For example, a user-to-user graph can be derived from visits to common locations, albeit at different times. As one example, each day's visitation data can be segmented into 24 one-hour blocks, and edge strengths between pairs of devices can be determined in correspondence with a number of shared visits between the devices within each one-hour block. A one-hour block is used by way of example, and other selected timeframes can be used. For example, a timeframe less than about one hour, e.g., less than about 30 minutes, with less than about 10 minutes being but one specific example. As another example, a timeframe longer than about one hour can be used, e.g., greater than about 4 hours, such as, for example, longer than about 12 hours, with longer than about 24 hours being a specific example. Of course, time can be measured in days, weeks, months, and seasons, and those scales of time may be suitable for determining similarity of preferences among users. For example, a pair of devices determined to visit a particular ski resort, albeit during different weeks, may be useful for determining a measure of similar athletic interests between users of those devices.

Another useful graph can be derived from nodes representing physical locations and edges connecting the nodes corresponding not to physical paths between the locations but rather based on users that visit the locations (either concurrently or within some other predefined timeframe as discussed above). For example, edges between such physical nodes can be strengthened according to the number and times of visits by each device. In another example, edges between such physical nodes can be strengthened according to visits by devices having a selected degree of similarity, even if a single device does not necessarily visit two nodes.

In one embodiment, similarity between pairs of devices is assessed according to a Riemann metric for a distance between embeddings of the devices (e.g., based on a projection of the embeddings onto a Riemann surface. A complement of the Riemann metric is the similarity between devices expressed as a percent: 0 (or completely dissimilar) through 100 (identical).

Once a full graph of user-to-user similarity has been determined, a segmentation model can place each device into a single behavioral audience based on the places, and visit behaviors, of the corresponding user (as expressed by the location-based data), as well as each user's actual or derived demographic information. Each cohort can be defined around a core set of behaviors that exemplify (or characterize) the corresponding group of users.

In some working embodiments, similarity among devices having a “home location” within a predefined geography can be assessed. Alternatively, as discussed more fully below, similarity among all devices reflected in an aggregation of location-based data, e.g., without regard to their “home location,” can be assessed and market segments can be defined based on locations of each cohort's members at a given time, and how those locations vary over time.

Devices, and thus users of those devices, sharing a similar parameter history can be assigned to a common group, or cohort based on that similarity. For example, similarity of devices can be assessed according to whether they visit common or similar locations and/or exhibit similar traits while at those locations (e.g., time of day, dwell, purpose, visit history). As another example, similarity can be assessed according to classes of activity expressed through each device's location-based information. Users deemed to be similar under either measure (e.g., location or activity) are believed likely to share common demographics and to express similar future behaviors.

Referring again to FIGS. 2 and 3 for purposes of illustration, aspects of Person A's behaviors are similar to aspects of Person B's behaviors. More particularly, both Person A and Person B workout at the same gym 12 and trail run (albeit on different trails 13, 22). Accordingly, Person A and Person B may be assigned to a common cohort whose members workout at the gym 12 (or another, e.g., similar) gym and regularly trail run.

With disclosed systems and methods, users can migrate between or among cohorts as each user's expressed behaviors evolve. Similarly, new cohorts can come into existence, e.g., based on changing seasonal behaviors or new locations being introduced into the data set.) As well, existing cohorts may become extinct (permanently or seasonally) based on the evolution of expressed behaviors. It is surmised that a behavioral cohort is a highly accurate predictor of future behavior of a user, far more so than the grouping by demographics alone would admit.

In a working embodiment, the entire model is trained weekly with an additional database containing location-based data. For practical reasons, given the amount of data involved and the computational overhead, the training is performed on a distributed GPU cluster using shared gradient descent updates on each step. Once the model is trained, inference can be performed on a single server with local GPUs.

In one working example, such a predefined geography can corresponding to a core-based statistical area (CBSA) boundary. The home location of each device in an aggregation of location-based data can be assigned to a single CBSA.

A CBSA is a U.S. geographic area defined by the Office of Management and Budget (OMB) that consists of one or more counties (or equivalents) anchored by an urban center of at least 10,000 people plus adjacent counties that are socio-economically tied to the urban center by commuting. Areas defined on the basis of these standards applied to Census 2000 data were announced by OMB in June 2003. On Jul. 15, 2015, OMB updated the 2010 Census-based federal statistical areas through Bulletin No. 15-01. The updates were based on the application of the 2010 Standards for Delineating Metropolitan and Micropolitan Statistical Areas to Census Bureau population estimates for Jul. 1, 2012, and Jul. 1, 2013, resulting in the designation of a new Metropolitan Statistical Area, new Micropolitan Statistical Areas, new Combined Statistical Areas, and new components of existing Combined Statistical Areas, as well as other changes.

### V. Route Completions and Location Prediction

With an aggregation of location-based information, each device's travel routes can be estimated over the time frame of the aggregation, even when the underlying database is relatively sparse. A database of location-based information can provide useful information regarding likely routes of travel taken by each mobile device. For example, referring again to FIG. 2, Person A's mobile device shows the device being at home 10 one morning, and a short time later at the intermediate location [symbol] along route 16a and at the school 14. Given those elements of location-based data from Person A's mobile device, it is unlikely that Person A traveled from home 12, to work 11 along route 18 and then back-tracked along route 17a,c to the school 14. Such information can readily be modeled by a Markov model that can determine a state of a variable without having the ability to observe the process used to arrive at the state.

In one working embodiment, a deep Markov model completes unobserved portions of each user's daily trips from their past patterns and patterns of similar users. The similar patterns can be derived or otherwise determined from an output of a cohort model as described above. For example, such a cohort model can provide partial trajectories that are contextually relevant for a given user and location whose route is to be completed.

For example, partially observed location-based data for a given device of interest (e.g., a small portion of available location-based data for the device) and data reflecting other devices' completed routes can be used to predict future locations of the device-of-interest. A prediction accuracy of the model can be determined, for example, by comparing predicted locations to observed locations of the device-of-interest which were not used in the predictions. During training, an error-minimization function can adjust the model and reduce error in predicted location (e.g., difference between predicted location and observed location).

With such a model, a full day's journey (or a longer- or a shorter-duration journey) for each user can be mapped. The journey can include businesses visited, as well as when and how long each user visited at each business. Further, the journey output can specify the routes and modes-of-transportation (e.g., bicycle, car, walking, etc.) used along each route. Described models are able to accurately predict routes taken by individuals, even in dense, highly noisy metro downtown areas like Manhattan where the GPS trace data can drift or otherwise be very uncertain. In some embodiments, each device's location can be determined to within several meters, which is far more accurate than cell networks are currently able to provide.

After training, each cohort member's 104a, 104b hourly, daily, weekly, monthly and seasonal travel routes 105a, 105b can be inferred with a high degree of accuracy. Accordingly, content can be curated responsive to each cohort's travel routes. Further, referring again to FIG. 1, the advertising curator 108 can present a curated content to each of one or more displays 101, 103 to achieve a desired level of reach (e.g., a total number of content impressions) and/or frequency (e.g., a measure of the number of impressions achieved per person). For example, the curated content to be communicated to each respective digital display 101, 103 over a corresponding network 112 connection 112a, 112b between the display and the content curator 108. Similarly, preferred locations for installing new displays can be determined to achieve a desired level of reach and/or frequency of various cohorts.

### VI. Cohort-Defined Market Boundaries

As described above, devices deemed to be similar to each other with respect to a given characteristic can be grouped together (e.g., assigned to a cohort reflective of that characteristic). As described more fully below, a cohort-based market boundary can be defined around each area containing a selected concentration of cohort members.

While members of a cohort defined using location-based data are not necessarily located near each other at any given time, some cohort members may be located in the same general vicinity as other cohort members during certain times. Moreover, a certain concentration of cohort members may, from time to time, be located in a given area, as revealed by the cohort and route-completion models described above.

Accordingly, a boundary of a cohort-defined market boundary that encloses a region containing a high concentration of cohort members may evolve and change over time as members of the cohort migrate and/or disperse from the region. For example, the boundary around one region may divide, e.g., as members of a cohort disperse. Similarly, multiple boundaries around dispersed groups of cohort members may merge together as groups of cohort members converge in a region.

As an example, a cohort may be defined based on trail running. Members of the cohort typically run several times each week, and a high percentage of the cohort members regularly run on a popular, forested trail within a given city's boundaries. The forested trail may have a limited number of trailheads, and thus, routes to the trailheads. In this example, a cohort-defined market boundary can be determined to encircle the forested trail and a portion of the route to each trailhead.

As noted above, a cohort-defined market boundary may be transient in nature. For example, a threshold concentration of cohort members may be in the area of the forested trail and along the routes approaching the trail only during certain hours on weekend mornings. Afterward, the cohort members may disperse throughout a large metropolitan area, where the concentration of cohort members may fall below the threshold concentration.

Certain content may be of particular interest to members of given cohort, but of little interest to others outside the cohort. Accordingly, a content curator may wish to present the content to cohort members only when and while the cohort members are concentrated in an area above a selected threshold concentration. In the trail-running example, the content curator may present a desired content along routes of travel to and from the forested trail, and only during times the cohort members are known to travel those routes.

### VII. Content Curation

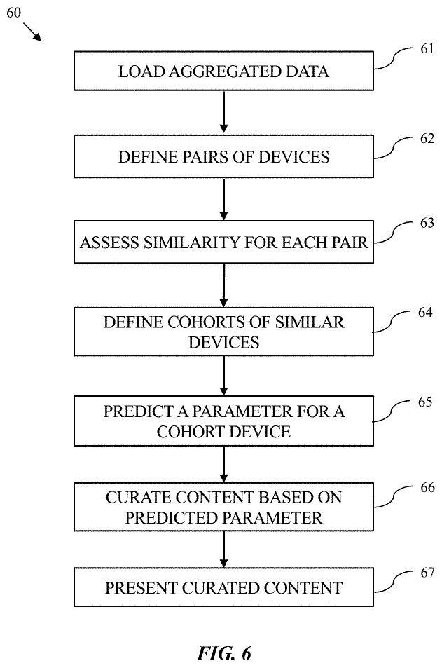

Generally, content can be curated in a manner likely to present the content to the cohort members. Referring now to FIGS. 5 and 6, methods for presenting content likely to be of-interest to members of a cohort are described.

In FIG. 5, a location-prediction method 50 is shown. Locations of cohort members can be predicted at one or more selected times, as indicated at block 51. At block 52, content likely to be of-interest to at least some of the cohort members can be identified. At block 53, the content can be presented, e.g., in a manner calculated to allow the cohort members to view the content.

A method 60 for tailoring content based on interests of mobile-device users is described in relation to FIG. 6. At block 61, aggregated location-based data is acquired. The acquisition can be by direct observation (e.g., as described above in connection with a data aggregator) or by obtaining a database of aggregated location-based data from, e.g., a data aggregator. At block 62, pairs of devices described by the location-based data are defined. In some embodiments, each device is paired with every other device described by the location-based data. At block 63, one or more measures of similarity is assessed for pair of devices. A cohort of similar devices based on a selected characteristic is defined at block 64. Each pair of devices assessed to be similar with regard to the selected characteristic is assigned to the cohort. At block 65, a parameter is predicted for a cohort device. For example, a location of the cohort device at a given time, or a time at which the cohort device is expected to be at a given location, can be predicted based on, for example, behaviors expressed by other cohort devices in the location-based data. At block 66, content is curated based on the predicted parameter. For example, content that may be of interest to members of a selected cohort may be identified. At block 67, the curated content is presented. For example, the curated content may be displayed on selected roadside signage contemplated to be viewed by a selected number of cohort members (e.g., reach) or to be viewed a selected number of times by each member of a cohort (e.g., frequency).

### VIII. Computing Environments

For succinctness, the foregoing description refers to mobile digital devices, or more simply mobile devices, that generate and communicate location-based data used in disclosed location prediction systems and related methods. Nonetheless, any of a wide variety of computing environments as described below can be associated with a user and can be used to generate and communicate location-based data.

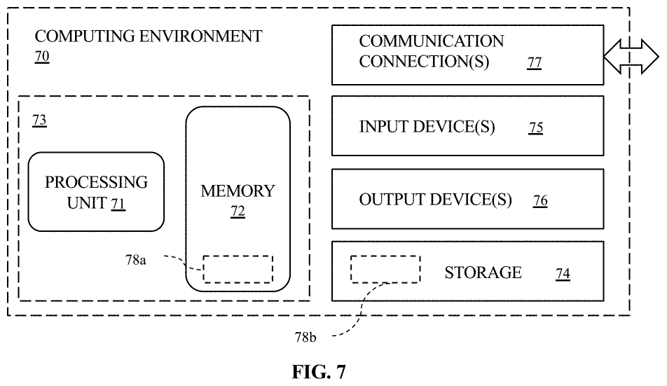

FIG. 7 illustrates a generalized example of a suitable computing environment 70 in which described methods, embodiments, techniques, and technologies relating, for example, to predicting locations of mobile devices, and users thereof, and/or curating content to such users having expressed similar preferences. The computing environment 70 is not intended to suggest any limitation as to scope of use or functionality of the technologies disclosed herein, as each technology may be implemented in diverse general-purpose or special-purpose computing environments. For example, each disclosed technology may be implemented with other computer system configurations, including multiprocessor systems, microprocessor-based or programmable consumer electronics, embedded platforms, fully-programmable network computers, minicomputers, mainframe computers, smartphones, tablet computers, data centers, and the like. Each disclosed technology may also be practiced in distributed computing environments where tasks are performed by remote processing devices that are linked through a communications connection or network. In a distributed computing environment, program modules may be located in both local and remote memory storage devices.

The computing environment 70 includes at least one central processing unit 71 and memory 72. In FIG. 7, this most basic configuration 73 is included within a dashed line. The central processing unit 71 executes computer-executable instructions and may be a real or a virtual processor. In a multi-processing system, multiple processing units execute computer-executable instructions to increase processing power and as such, multiple processors can run simultaneously. As but one example of a suitable processing unit, one working embodiment uses a plurality of processing cards available from NVIDIA Corporation under the mark VOLTA®.

The memory 72 may be volatile memory (e.g., registers, cache, RAM), non-volatile memory (e.g., ROM, EEPROM, flash memory, etc.), or some combination of the two. The memory 72 stores software 78a that can, for example, implement one or more of the innovative technologies described herein, when executed by a processor.

A computing environment may have additional features. For example, the computing environment 70 includes storage 74, one or more input devices 75, one or more output devices 76, and one or more communication connections 77. An interconnection mechanism (not shown) such as a bus, a controller, or a network, interconnects the components of the computing environment 70. Typically, operating system software (not shown) provides an operating environment for other software executing in the computing environment 70, and coordinates activities of the components of the computing environment 70.

The store 74 may be removable or non-removable, and can include selected forms of machine-readable media. In general machine-readable media includes magnetic disks, magnetic tapes or cassettes, non-volatile solid-state memory, CD-ROMs, CD-RWs, DVDs, magnetic tape, optical data storage devices, and carrier waves, or any other machine-readable medium which can be used to store information and which can be accessed within the computing environment 70. The storage 74 stores instructions for the software 78, which can implement technologies described herein.

The store 74 can also be distributed over a network so that software instructions are stored and executed in a distributed fashion. In other embodiments, some of these operations might be performed by specific hardware components that contain hardwired logic. Those operations might alternatively be performed by any combination of programmed data processing components and fixed hardwired circuit components.

The input device(s) 75 may be a touch input device, such as a keyboard, keypad, mouse, pen, touchscreen, touch pad, or trackball, a voice input device, a scanning device, or another device, that provides input to the computing environment 70. For audio, the input device(s) 75 may include a microphone or other transducer (e.g., a sound card or similar device that accepts audio input in analog or digital form), or a computer-readable media reader that provides audio samples to the computing environment 70. For data input, e.g., of an aggregation of location-based data, the input device may be a network connection.

The output device(s) 76 may be a display, printer, speaker transducer, DVD-writer, or another device that provides output from the computing environment 70. For example, as noted above, some computing environments include one or more displays. In some contemplated systems, the computing environment constitutes a distributed computing environment having one or more remotely positioned displays on which curated content can be presented. As but one example, such a display can be a digital billboard or other controllable signage suited for indoor and/or outdoor service. As but one specific example, contemplated displays include a digital billboard of the type that can be positioned alongside a highway, freeway, or other travel corridor. In other examples, contemplated displays include digital or other controllable signage mounted to a building or other outdoor or indoor structure.

The communication connection(s) 77 enable communication over a communication medium (e.g., a connecting network) to another computing entity. The communication medium conveys information such as computer-executable instructions, compressed graphics information, processed signal information (including processed audio signals), or other data in a modulated data signal.

Thus, disclosed computing environments are suitable for performing location-prediction and content-curation processes as disclosed herein.

Machine-readable media are any available media that can be accessed within a computing environment 70. By way of example, and not limitation, with the computing environment 70, machine-readable media include memory 72, storage 74, communication media (not shown), and combinations of any of the above. Tangible machine-readable (or computer-readable) media exclude transitory signals.

As explained above, some disclosed principles can be embodied in a tangible, non-transitory machine-readable medium (such as microelectronic memory) having stored thereon instructions, which program one or more data processing components (generically referred to here as a “processor”) to perform the digital signal processing operations described above including estimating, adapting, learning, inferring, computing, calculating, measuring, adjusting assessing, sensing, measuring, filtering, addition, subtraction, inversion, comparisons, and decision making. In other embodiments, some of these operations (of a machine process) might be performed by specific electronic hardware components that contain hardwired logic (e.g., dedicated digital filter blocks). Those operations might alternatively be performed by any combination of programmed data processing components and fixed hardwired circuit components.

### IX. Other Exemplary Embodiments

The examples described above generally concern systems, methods and techniques for predicting places a person will likely visit based at least in part on observed behaviors of one or more members of a cohort to which the person belongs, as well, in some instances, to curating content responsive to such predictions. The previous description is provided to enable a person skilled in the art to make or use the disclosed principles. Embodiments other than those described above in detail are contemplated based on the principles disclosed herein, together with any attendant changes in configurations of the respective apparatus or changes in order of method acts described herein, without departing from the spirit or scope of this disclosure. Various modifications to the examples described herein will be readily apparent to those skilled in the art.

Directions and other relative references (e.g., up, down, top, bottom, left, right, rearward, forward, etc.) may be used to facilitate discussion of the drawings and principles herein, but are not intended to be limiting. For example, certain terms may be used such as “up,” “down,”, “upper,” “lower,” “horizontal,” “vertical,” “left,” “right,” and the like. Such terms are used, where applicable, to provide some clarity of description when dealing with relative relationships, particularly with respect to the illustrated embodiments. Such terms are not, however, intended to imply absolute relationships, positions, and/or orientations. For example, with respect to an object, an “upper” surface can become a “lower” surface simply by turning the object over. Nevertheless, it is still the same surface and the object remains the same. As used herein, “and/or” means “and” or “or”, as well as “and” and “or.” Moreover, all patent and non-patent literature cited herein is hereby incorporated by reference in its entirety for all purposes.

And, those of ordinary skill in the art will appreciate that the exemplary embodiments disclosed herein can be adapted to various configurations and/or uses without departing from the disclosed principles. Applying the principles disclosed herein, it is possible to provide a wide variety of location-prediction and/or content curation systems, and to practice related methods. For example, the principles described above in connection with any particular example can be combined with the principles described in connection with another example described herein. Thus, all structural and functional equivalents to the features and method acts of the various embodiments described throughout the disclosure that are known or later come to be known to those of ordinary skill in the art are intended to be encompassed by the principles described and the features and acts claimed herein. Accordingly, neither the claims nor this detailed description shall be construed in a limiting sense, and following a review of this disclosure, those of ordinary skill in the art will appreciate the wide variety of location-prediction and/or content curation systems, and related methods that can be devised under disclosed and claimed concepts.

Moreover, nothing disclosed herein is intended to be dedicated to the public regardless of whether such disclosure is explicitly recited in the claims. No claim feature is to be construed under the provisions of 35 USC 112(f), unless the feature is expressly recited using the phrase “means for” or “step for”.

The appended claims are not intended to be limited to the embodiments shown herein, but are to be accorded the full scope consistent with the language of the claims, wherein reference to a feature in the singular, such as by use of the article “a” or “an” is not intended to mean “one and only one” unless specifically so stated, but rather “one or more”.

Thus, in view of the many possible embodiments to which the disclosed principles can be applied, we reserve the right to claim any and all combinations of features and acts described herein, including the right to claim all that comes within the scope and spirit of the foregoing description, as well as the combinations recited, literally and equivalently, in any claims presented anytime throughout prosecution of this application or any application claiming benefit of or priority from this application, and more particularly but not exclusively in the claims appended hereto.

1. A computing environment having a display, a processor and a memory containing instructions that, when executed by the processor, cause the computing environment to:
predict a location of a member of a cohort of devices from a prior location of the member and a record of observations of one or more other devices in the cohort;
curate a content responsive to one or more behavioral attributes of the cohort; and
present the curated content on the display responsive to the predicted location of the member being within a selected proximity of the display.

2. The computing environment according to claim 1, wherein the computing environment comprises a network-distributed computing environment.

3. The computing environment according to claim 1, wherein the display comprises a kiosk display.

4. The computing environment according to claim 1, wherein the selected proximity comprises between about 1 meter and about 5 meters.

5. The computing environment according to claim 1, wherein the display comprises a billboard display positioned within viewing distance of a travel corridor.

6. The computing environment according to claim 1, wherein the selected proximity comprises between about 100 meters and about 800 meters.

7. The computing environment according to claim 1, wherein the record of observations comprises a record of locations where each of the one or more other devices in the cohort has been observed, a record of behavioral attributes of each of the one or more other devices, or a combination thereof.

8. The computing environment according to claim 1, wherein the instructions, when executed by the processor, further cause the computing environment to define the cohort of devices from among a plurality of devices based on an assessment of similarity of a parameter history of each device in the plurality of devices to the parameter history of each other device in the plurality of devices.

9. The computing environment according to claim 8, wherein the parameter history comprises a record of locations where the respective device has been observed, a record of inferred activities conducted by a user of the respective device, or a combination thereof.

10. The computing environment according to claim 1, wherein the display comprises a first display positioned at a first location, wherein the computing environment comprises a second display positioned at a second location, and wherein the instructions, when executed by the processor, further cause the computing environment to present the curated content on the first display responsive to the predicted location of the member being within a selected proximity of the first display.

11. The computing environment according to claim 10, wherein the instructions, when executed by the processor, further cause the computing environment to present the curated content on the second display responsive to the predicted location of the member being within a selected proximity of the second display.

12. A computing environment having a processor, a communication connection, and a memory containing instructions that, when executed by the processor, cause the computing environment to:
determine a plurality of parameters corresponding to each respective device in a plurality of devices;
define a plurality of pairs of the devices, wherein each pair consists of a selected one of the plurality of devices and a selected one other of the plurality of devices;
for each defined pair, determine a measure of similarity between at least one of the parameters corresponding to one of the devices in the pair and at least one of the parameters corresponding to the other device in the pair;
define a cohort of devices corresponding to each at least one of the parameters and assign to the respective cohort each pair of devices for which the corresponding measure of similarity exceeds or falls below a threshold measure of similarity;
for at least one device in a selected cohort of devices, predict a second parameter value of the respective device based on a known first parameter value of the respective device and one or more trajectories of changes in parameter value of other devices in the cohort of devices; and
provide an output over the communication connection in correspondence with the predicted second parameter value.

13. The computing environment according to claim 12, wherein the plurality of parameters corresponding to each respective device comprises one or more position-related parameters, one or more behavior-related parameters, one or more demographic-related parameters, one or more health-related parameters, or a selected combination of one or more position-related parameters, one or more behavior-related parameters, one or more demographic-related parameters, and one or more health-related parameters.

14. The computing environment according to claim 13, wherein the one or more position-related parameters comprises one or more of a latitude, a longitude, an elevation, a date, a time, a year, a dwell, a purpose, an activity history, a transaction information, a speed of travel, a direction of travel, a weather information, an environment information, a sound information, an atmospheric information.

15. The computing environment according to claim 13, wherein the one or more behavior-related parameters comprise an activity, a response to a stimulus, a travel speed, a path of travel, a dwell time at a selected type of location.

16. The computing environment according to claim 13, wherein the one or more demographic-related parameters comprises demographic information of a user of the respective device.

17. The computing environment according to claim 13, wherein the one or more health-related parameters comprises health-related information of a user of the respective device.

18. The computing environment according to claim 13, wherein the measure of similarity between at least one of the parameters corresponding to one of the devices in the pair and at least one of the plurality of parameters corresponding to the other device in the pair comprises a measure of similarity between at least one position-related parameter corresponding to the one of the devices and at least one of position-related parameter corresponding to the other device in the pair.

19. The computing environment according to claim 12, wherein the first parameter value comprises a first location characteristic and the second parameter value comprises a second location characteristic.

20. The computing environment according to claim 19, wherein the first location characteristic comprises a geographic position, a business identification, a business type, an activity, a measure of weather, a landscape classification, a development classification, and a classification of wildlife habitat.

21. The computing environment according to claim 12, wherein the instructions, when executed by the processor, further cause the computing environment to define a geographical boundary corresponding to the cohort.

22. The computing environment according to claim 21, wherein the instructions, when executed by the processor, further cause the computing environment to define an evolution of the geographical boundary over a selected time frame.

23. A computing environment having a display positioned in a region, a processor and a memory containing instructions that, when executed by the processor, cause the computing environment to:
predict a location of each member of a cohort containing a plurality of devices from a prior location of the member and a record of observations of one or more other devices in the cohort;
assess a concentration of cohort devices within the region in relation to a threshold concentration; and
present a content on the display responsive to the assessed concentration of cohort devices exceeding the threshold concentration.

24. The computing environment according to claim 23, wherein the display comprises a first display, the region comprises a first region, and the threshold concentration comprises a first concentration, wherein the computing environment further comprises a second display positioned in a second region, and wherein the instructions, when executed by the processor, further cause the computing environment to:
assess a concentration of cohort devices within the second region in relation to the second threshold concentration; and
to present the content on the second display responsive to the second concentration of cohort devices exceeding the second threshold concentration.

25. The computing environment according to claim 24, wherein the first threshold concentration is equal to the second threshold concentration.

26. The computing environment according to claim 23, wherein the computing environment comprises a network-distributed computing environment.

27. The computing environment according to claim 23, wherein the instructions that, when executed by the processor, cause the computing environment to assess a concentration of cohort devices, further cause the computing environment, responsive to the assessed concentration of cohort devices within the region exceeding the threshold concentration, to determine a duration the assessed concentration of cohort devices within the region will exceed the threshold concentration, and wherein the instructions that, when executed by the processor, cause the computing environment to present a content on the display, further cause the computing environment to present the content on the display during the duration the assessed concentration of cohort devices exceeds the threshold concentration.
